(19) United States
(12) Patent Application Publication
(10) Pub. No.: US 2018/0037013 A1
(43) Pub. Date: Feb. 8, 2018

(54) CURABLE ORGANOPOLYSILOXANE COMPOSITION, A USE THEREOF, AND A LAMINATE PREPARED FROM THE COMPOSITION

(71) Applicants: Dow Corning Toray Co., Ltd., Tokyo (JP); Dow Corning (China) Holding Co., Ltd., Shanghai (CN)

(72) Inventors: Shuji ENDO, Chiba (JP); Takakazu HINO, Chiba (JP); Junping HUO, Shanghai (CN); Yangyun LUO, Shanghai (CN); Haruna MIZUNO, Chiba (JP); Hidefumi TANAKA, Chiba (JP); Shoko TANAKA, Chiba (JP)

(21) Appl. No.: 15/555,119

(22) PCT Filed: Mar. 5, 2015
(86) PCT No.: PCT/CN2015/073686

§ 371 Date: Sep. 1, 2017

(51) Int. Cl. B32B 27/28; C09J 183/04; C09D 183/04

(52) U.S. Cl. CPC B32B 27/283; C09D 183/04; C09J 183/04; C08G 77/12

(57) ABSTRACT

A curable organopolysiloxane composition comprising: (A) an organopolysiloxane having at least two alkenyl groups in each molecule; (B) an organohydrogenpolysiloxane in an amount sufficient to provide a value of 1.1:1 to 20:1 (SiH:alkenyl group) for the molar ratio of silicon-bonded hydrogen atoms in the organohydrogenpolysiloxane to the alkenyl groups in component (A), wherein component (B) consists of the following components (B1) and (B2) at a mass ratio of (B1)/(B2) in the range from 100/0 to 15/85: (B1) an organohydrogenpolysiloxane having at least three silicon-bonded hydrogen atoms in each molecule and a silicon-bonded hydrogen content [Si—H] mass % satisfying the following equation: 0<[Si—H] mass %<5/(DP)^{0.5} wherein the DP is in the range from 5 to 1000; (B2) an organohydrogenpolysiloxane having at least one silicon-bonded hydrogen atom in each molecule, which is different from the component (B1); and (C) a hydrosilation reaction catalyst in a catalytic amount.

### FIELD OF THE INVENTION

The present invention relates to a curable organopolysiloxane composition, in particular a curable organosiloxane composition which is useful in forming a pressure-sensitive adhesive layer on a substrate. The present invention also relates to a laminate, which is an article comprising a cured organopolysiloxane layer formed from the curable organopolysiloxane composition, such as a protective film having a pressure-sensitive adhesive layer for protecting a surface of a substrate. However, the curable organopolysiloxane composition of the present application is not limited to a composition which is used as a material for a pressure-sensitive adhesive, and may be used in other applications such as a coating material like a release coating material and a primer.

### BACKGROUND OF THE INVENTION

A curable organopolysiloxane composition comprising an organopolysiloxane having alkenyl groups, an organopolysiloxane having silicon atom-bonded hydrogen atoms (Si—H), and a hydrosilation catalyst such as a platinum compound is widely known and used for a wide variety of applications. One of the applications of a curable organopolysiloxane composition is a pressure-sensitive adhesive. Curable organopolysiloxane compositions applicable for a pressure-sensitive adhesive are also widely known.

A siloxane is a compound which contains at least one Si—O bond.
A polysiloxane contains several —Si—O—Si— bonds forming a polymeric chain, where the repeating unit is —(Si—O)—. An organopolysiloxane is sometimes called a silicone. An organopolysiloxane contains repeating —(Si—O)— units where at least one Si atom bears at least one organic group. “Organic” means containing at least one carbon atom. An organic group is a chemical group comprising at least one carbon atom.
A polysiloxane comprises terminal groups and pendant groups.
A polysiloxane can typically comprise one, two or more of the following units types: M unit (mono-functional), D unit (di-functional), T unit (tri-functional), Q unit (tetra-functional). A M unit typically has the formula R₃SiO_{0.5}. A D unit typically has the formula R₂SiO_{2/2}. A T unit typically has the formula RSiO_{1.5}. A Q unit typically has the formula SiO_{2.0}. R is a substituent, preferably an organic substituent. Each substituent R can be the same or different on one Si atom. R can be selected for example from alkyl, for example methyl, aryl, for example phenyl, alkenyl, for example vinyl or hexenyl, acrylate, methacrylate and others.
A linear polysiloxane typically contains D units and terminal M units. A branched polysiloxane also called a resin typically contains at least one T unit and/or at least one Q unit. An MQ resin is an organopolysiloxane containing at least one M unit and at least one Q unit.
Hydrosilation is an addition reaction where a compound containing at least one unsaturated bond, for example alkenyl, reacts with a compound containing at least one Si—H bond.

Japanese Patent No. 4678847 (Patent Document 1) discloses a pressure-sensitive adhesive film composed of a base film and an adhesive layer formed on one side of the film, wherein the adhesive layer is prepared from a curable organopolysiloxane composition comprising (A) a diorganopolysiloxane having at least two alkenyl groups per molecule, (B) an MQ resin in which the molar ratio of M units to Q units (M/Q) is in the range from 0.6 to 1.7, and (C) an organopolysiloxane having Si—H groups, where the molar ratio of Si—H to alkenyl groups is in the range from 0.5 to 20. Patent Document 1 discloses that component (C) may be a linear, branched, or cyclic organohydrogenpolysiloxane having at least two silicon atom-bonded hydrogen atoms per molecule and that component (C) preferably has a viscosity of from 1 to 5,000 (=5000.00) mPa·s at 25° C. Patent Document 1 also discloses that the molar ratio of the Si—H groups in component (C) to the alkenyl groups in component (A) is in the range from 0.5 to 20. The organohydrogenpolysiloxane specifically used in the examples disclosed in Patent Document 1 is a linear methylhydrogenpolyorganosiloxane represented by the following formula:

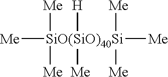

which has 42 siloxane units, and the amount of silicon atom-bonded hydrogen atoms is 1.65 mass %.

Japanese Patent No. 4678817 (Patent Document 2) discloses a curable organopolysiloxane composition which may be used for a pressure-sensitive adhesive tape, which comprises (A) an organopolysiloxane having at least two alkenyl groups per molecule wherein the amount of the alkenyl groups is in the range from 0.0015 to 0.06 mole/100 g of the polymer, (B) an MQ resin, and (C) an organohydrogenpolysiloxane having 3 or more Si—H groups per molecule wherein the molar ratio of siloxane units having SiH/siloxane units which have no Si—H groups is in the range from 5/1 to 9/1. Patent Document 2 also discloses that the molar ratio of the Si—H groups in component (C) to the alkenyl groups in component (A) is in the range from 0.1 to 20. The organohydrogenpolysiloxane specifically used in the examples disclosed in Patent Document 2 is a linear methylhydrogenpolyorganosiloxane represented by the following formula:

Me₃SiO-[MeHSiO]₄₅-[Me₂SiO]₁₇—SiMe₃

which has 64 siloxane units, and the amount of silicon atom-bonded hydrogen atoms is 1.65 mass %.

Japanese Patent Application, Unexamined First Publication No. 2011-46174 (Patent Document 3) discloses a curable organopolysiloxane composition and a laminated article composed of a substrate, such as a sheet of glass, silicon wafer, a metal plate and the like, and an organopolysiloxane layer formed from the curable organopolysiloxane composition. Patent Document 3 also discloses that another glass substrate may be attached to the organopolysiloxane layer of the laminated article, and the glass substrate is separated from the laminated article after the glass substrate has been processed. The curable organopolysiloxane composition disclosed in Patent Document 3 comprises (a) a linear organopolysiloxane having at least two alkenyl groups and (b) a linear organohydrogenpolysiloxane having at least three silicon atom-bonded hydrogen atoms wherein at least one of the silicon atom-bonded hydrogen atoms is bonded to the silicon atom at the terminal of the polymer chain, and wherein the molar ratio of the silicon atom-bonded hydrogen atoms to the alkenyl groups (Si—H/alkenyl) is in the range from 0.7 to 1.05. The examples in Patent Document 3 disclose organohydrogenpolysiloxanes represented by the following formula:

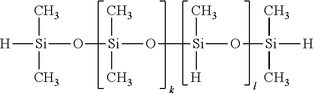

wherein k=40 and l=40 for organohydrogensiloxane A, or k=100 or l=8 for organohydrogensiloxane B disclosed in the examples. Therefore, organohydrogensiloxane A has 82 siloxane units and 0.732 mass % of silicon atom-bonded hydrogen atoms. In addition, Patent Document 3 discloses that if the aforementioned molar ratio (Si—H/alkenyl) is greater than 1.05, the releasing properties of the cured organopolysiloxane composition from the glass substrate will deteriorate. In other words, Patent Document 3 discloses that the molar ratio (Si—H/alkenyl) of a curable organopolysiloxane composition should be lower than 1.05 in order to prepare an adhesive layer which exhibits good releasing properties.

One application of a pressure sensitive adhesive is a protective film, which is attached to an article, typically a substrate such as a glass sheet to be protected during storage or transportation thereof. In this application, the protective film is used temporarily and removed from the article when the article is further processed or used. Therefore, it is desired that when the protective film composed of a base film and a pressure-sensitive adhesive layer is removed from the article to be protected, no residues of the pressure-sensitive adhesive material remain on the surface of the article. In addition, in order to reduce a cycle time of manufacturing a product by using the article, it is also desired that a curable pressure-sensitive organopolysiloxane composition can be cured rapidly and can be easily removed from the surface of an article to be protected.

### SUMMARY OF THE INVENTION

As described above, curable organopolysiloxane compositions for use in preparing a pressure-sensitive adhesive or a laminate such as an adhesive film or protective film composed of a substrate and a layer of cured organopolysiloxane composition are known. However, it is still desired to develop a curable organopolysiloxane composition which can be cured rapidly, and a cured pressure-sensitive adhesive produced from the curable composition that can be easily removed from the surface of an article to which the adhesive is attached without any residues remaining or only an acceptable small amount of residues from the pressure-sensitive adhesive remaining on the surface of the article. The objective of the present invention is to provide a novel curable organopolysiloxane composition which can solve the aforementioned problems. The inventors of the present invention found that the objective of the present invention can be solved by using an organohydrogenpolysiloxane which has a relatively low degree of polymerization (DP) and a relatively small content of silicon atom-bonded hydrogen atoms (Si—H) as is defined in the claims and the specification. However, the curable organopolysiloxane composition of the present invention is novel and may be used for applications other than a pressure-sensitive adhesive composition and the like specifically disclosed in the examples of the present invention, and thus applications of the curable organopolysiloxane composition of the present invention are not limited to a pressure-sensitive adhesive composition and a protective film using the same.

The curable organopolysiloxane composition of the present invention comprises the following components:

(A) an organopolysiloxane having at least two alkenyl groups in each molecule;
(B) an organohydrogenpolysiloxane in an amount sufficient to provide a value from 1.1:1 to 20:1 (Si—H:alkenyl group), preferably from 1.5:1 to 10:1, more preferably from 2:1 to 1 to 8:1, and most preferably 3:1 to 6:1, for the molar ratio of silicon-bonded hydrogen atoms in the organohydrogenpolysiloxane to the alkenyl groups in the component (A), wherein the component (B) consists of the following components (B1) and (B2) at a mass ratio of (B1)/(B2) in the range from 100/0 to 15/85, preferably 20/80, and more preferably 15/85:

(B1) an organohydrogenpolysiloxane having at least three silicon-bonded hydrogen atoms in each molecule and a silicon-bonded hydrogen content [Si—H]mass % satisfying the following equation:

0<[Si—H]mass %<5/(DP)^{0.5}

wherein DP designates the average number of siloxane units in each molecule calculated by the number average molecular weight of component (B1), and said DP is in the range from 5 to 1000;

(B2) an organohydrogenpolysiloxane having at least one silicon-bonded hydrogen atom in each molecule, which is different from the component (B1); and

(C) a hydrosilation reaction catalyst in a catalytic amount.

For the curable organopolysiloxane composition of the present invention, it is preferred that 50 mol % or more of all the terminal siloxy-groups of component (B1) have at least one silicon-bonded hydrogen atom.

It is also preferred that, for the curable organopolysiloxane composition described above, the [Si—H] mass % of said component (B1) satisfies following equation:

0<[Si—H]mass %<3.5/(DP)^{0.5}

wherein DP is as defined above and in claim 1, and said DP is in the range from 5 to 500.

The curable organopolysiloxane composition of the present application may further comprise an organopolysiloxane resin comprising R₃SiO_{0.5} (R is independently a monovalent organic group) units and at least one of RSiO_{1.5} units (R is a monovalent organic group) or SiO_{2.0} units, and the content of the organopolysiloxane resin may be less than 40 mass % of the total amount of the solid components of the composition.

The present invention also provides a curable organopolysiloxane composition comprising the organopolysiloxane resin described in the preceding paragraph,

wherein the component (A) is (A1) an organopolysiloxane having at least two alkenyl groups in each molecule with an alkenyl content in the range of from 0.005 to 1.50 mass %,
component (B) is (B1′) an organohydrogenpolysiloxane having at least three silicon-bonded hydrogen atoms, wherein the average number (DP) of siloxane units in each molecule calculated from the number average molecular weight is in the range from 8 to 300; 50 mol % or more of all the terminal siloxy-groups of component (B1′) have at least one silicon-bonded hydrogen atom; the [Si—H] mass % of said component (B1′) satisfies following equation:

0<[Si—H]mass %<3.5/(DP)^{0.5}

and;
the content of the organopolysiloxane resin comprising R₃SiO_{0.5} (R is independently a monovalent organic group) units and at least one of RSiO_{1.5} units (R is a monovalent organic group) or SiO_{2.0} units is equal to or less than 20 mass % of the total amount of the solid components contained in the composition.

It is preferred that the curable organopolysiloxane composition have the following properties: when a cured layer having a thickness of 30 μm is formed from the curable organopolysiloxane composition on a polyethylene terephthalate film having a thickness of 75 μm, the adhesive strength of the cured layer to the film is in the range from 0.5 to 20.0 gf/25 mm as measured according to the 180-degree peel test method specified in the Japanese Industrial Standards Z 0237. It is desired that types and amounts of the components contained in the curable organopolysiloxane composition of the present invention are decided so that the aforementioned properties of the cured layer formed from the curable composition are achieved.

The adhesive strength described in the preceding paragraph is preferably in the range from 0.5 to 15.0 gf/25 mm as measured according to the 180-degree peel test method specified in the Japanese Industrial Standards Z 0237.

One embodiment of the curable organopolysiloxane composition of the present invention is free or substantially free from an organopolysiloxane resin comprising R₃SiO_{0.5} (R is independently a monovalent organic group) units and at least one of RSiO_{1.5} units (R is a monovalent organic group) or SiO_{2.0} units, and the composition is capable of being cured to produce a cured layer on a substrate, wherein the composition has the following properties: when a cured layer having a thickness of 30 μm is formed from the composition on a polyethylene terephthalate film having a thickness of 75 μm, the adhesive strength of the cured layer to the film is in the range from 0.5 to 10.0 gf/25 mm as measured according to the 180-degree peel test method specified in the Japanese Industrial Standards Z 0237.

The curable organopolysiloxane composition of the present invention is preferably used as a primer composition, an adhesive composition including a pressure-sensitive adhesive composition, and a coating composition.

One embodiment of the present invention relates to a pressure-sensitive adhesive (PSA) composition consisting of a cured composition prepared from the curable organopolysiloxane composition of the present invention. The curable composition of the present invention is particularly useful for preparing a pressure-sensitive adhesive.

The curable composition of the present invention is also useful as a release coating composition consisting of the curable organopolysiloxane composition of the present invention. Therefore, the present invention also relates to such a release coating composition and a release coating prepared from the composition.

The present invention also provides an article comprising a layer of cured organopolysiloxane composition which is prepared by curing the curable organopolysiloxane composition of the present invention described above.

The present invention also relates to a laminate comprising a substrate and a layer of cured organopolysiloxane composition which is prepared by curing the curable organopolysiloxane composition of the present invention in the form of a thin film.

Regarding the laminate described above, the layer of a cured composition is preferably at least one selected from the group consisting of an adhesive layer, a release coating layer, and a primer layer.

One embodiment of the present invention relates to an optical article comprising the laminate described above.

The present invention also provides a protective film comprising the laminate described above.

The present invention also provide a method for producing a laminate, wherein the method comprises a step of applying the curable organopolysiloxane composition of the present invention on at least one side of a sheet-form substrate with a multiple-roll coater.

The curable organopolysiloxane composition of the present invention achieves one or more of the advantageous effects described below:

(i) The cured layer prepared from the curable organopolysiloxane composition of the present invention exhibits a very low level of migration of materials or no or substantially no visually detectable migration of materials from the cured layer to the surface of a substrate to which the cured layer was attached, after the cured layer is removed from the surface of the substrate.
(ii) It is possible to design an adhesive layer formed from a cured organopolysiloxane composition, which has a low adhesive strength to a substrate, and thus the adhesive layer can be easily removed from the substrate.
(iii) The curable organopolysiloxane composition of the present invention can be easily handled, and a cured layer can be rapidly prepared.
(iv) It is possible to formulate the curable composition of the present invention which has the desired properties without incorporating a silicone resin such as a MT resin or MQ resin into the composition. It is also possible to add at least one of a MT or MQ resin if desired.

### DESCRIPTION OF THE DRAWINGS

FIG. 1 shows the degree of migration of materials from the cured organopolysiloxane layer to the surface of the glass sheet under different situations including S, A, B, C, and D, wherein Line 1 represents the plotted line showing the value of 5/(DP)^{0.5}, and Line 2 represents the plotted line showing the value of 3.5/(DP)^{0.5}.

### DETAILED DESCRIPTION OF THE INVENTION

As described above, the curable organopolysiloxane composition of the present invention comprises the following components (A), (B), and (C) as essential elements:

(A) an organopolysiloxane having at least two alkenyl groups in each molecule;
(B) an organohydrogenpolysiloxane consisting of the following components (B1) and (B2):

(B1) an organohydrogenpolysiloxane having at least three silicon-bonded hydrogen atoms in each molecule and a silicon-bonded hydrogen content [Si—H]mass % satisfying the following equation:

0<[Si—H]mass %<5/(DP)^{0.5},

more preferably, 0<[Si—H]mass %<3.5/(DP)^{0.5}

wherein DP designates the average number of siloxane units in each molecule calculated by the number average molecular weight of component (B1), and the DP is in the range from 5 to 1000, preferably 5 to 500, more preferably 8 to 200, and most preferably 12 to 120;

(B2) an organohydrogenpolysiloxane having at least one silicon-bonded hydrogen atom in each molecule, which is different from the component (B1);

wherein each of component (B1) and component (B2) is used in such an amount that a mass ratio of component (B1)/component (B2) is in the range from 100/0 to 15/85, preferably 20/80, and more preferably 25/75; and
(C) a hydrosilation reaction catalyst in a catalytic amount which is sufficient to cause the hydrosilation reaction between component (A) and component (B) to proceed and cure the composition.

The equations: 0<[Si—H] mass %<5/(DP)^{0.5} and 0<[Si—H] mass %<3.5/(DP)^{0.5} described above are derived from experimental data using many different organohydrogenpolysiloxanes as component (B1), which are shown in the examples.

In addition, the curable organopolysiloxane composition of the present invention contains each of components (A) and (B) in such an amount that the molar ratio of the total silicon atom-bonded hydrogen atoms contained in component (B) to the total alkenyl groups contained in component (A) is in the range from 1.1:1 to 20:1 (Si—H:alkenyl), preferably from 1.5:1 to 10:1, more preferably from 2:1 to 1 to 8:1, and most preferably 3:1 to 6:1. By adjusting the ratio of the silicon atom-bonded hydrogen atoms to the alkenyl groups to the aforementioned range, the desired effects of the present invention such as good curability of the curable composition and low migration of materials from the cured composition to the surface of a substrate to which the cured composition was attached are achieved.

Components (A), (B1), (B2), and (C), and other possible additives used for the present invention are explained in detail below.

[Component A]

Component A is an organopolysiloxane having at least two alkenyl groups in each molecule or a combination of two or more organopolysiloxanes each having at least two alkenyl groups in each molecule. An organopolysiloxane having at least two alkenyl groups in each molecule is represented by the following general formula:

(R^{a1}₃SiO_{1/2})ₘ₁(R^{a2}₂SiO_{2/2})ₘ₂(R^{a3}SiO_{3/2})ₘ₃ (1)

wherein R^{a1}, R^{a2}, and R^{a3} are each independently selected from the group consisting of hydroxyl group, alkoxy group having 1 to 3 carbon atom such as methoxy, ethoxy groups, alkyl groups having 1 to 8 carbon atoms such as methyl, ethyl, propyl, butyl, hexyl and octyl groups, alkenyl groups having 2 to 8 carbon atoms, a phenyl group, and phenyl groups substituted with an alkyl group having 1 to 8 carbon atoms or a halogen atom such as a fluorine atom, wherein at least two of R^{a1}, R^{a2}, and R^{a3} moieties on the silicone atoms of the organopolysiloxane molecule of formula (1) are alkenyl groups capable of reacting with a Si—H group in the presence of a hydrosilation catalyst.
The alkenyl group may be selected from 1-alkenyl groups such as vinyl, allyl, 1-butenyl, 1-pentenyl, 1-hexenyl, 1-heptenyl, and 1-octenyl groups. Subscripts m1, m2, and m3 each independently represent a number of the corresponding repeating unit in the molecule, where one or two of m1, m2, and m3 may be zero, but m2 and m3 are not zero at the same time, with the proviso that m1+m2+m3 is a number that provides the organopolysiloxane of formula (1) with a viscosity at 25° C. of from 10,000 to 150,000 mPa·s, or a plasticity (mm) from 0.5 to 10.0 mm as measured according to JIS K-6249. Preferably, the plasticity was in a range from 0.9 to 3.0 mm.

The organopolysiloxane used as component (A) may be a linear, a branched, or a cyclic organopolysiloxane. An organopolysiloxane having a linear or branched organopolysiloxane chain, to which a cyclic organopolysiloxane moiety is further bonded, may also be used as component (A). Two or more same or different types of organopolysiloxanes may be used in combination as component (A).

An organopolysiloxane which is most preferably used as component (A) is a linear organopolysiloxane represented by the following chemical formula:

(R^{a1}₂R^{b1}SiO)—[(R^{a2}R^{b1}SiO_{2/2})ₙ₁(R^{a2}₂SiO_{2/2})ₙ₂]—(SiR^{a1}₂R^{b1}) (2)

wherein R^{a1} and R^{a2} each independently represents hydroxyl group, alkoxy group having 1 to 3 carbon atom such as methoxy, ethoxy groups, an alkyl group having 1 to 8 carbon atoms such as methyl, ethyl, propyl, butyl, hexyl and octyl groups, preferably a methyl group, or a phenyl group or a phenyl group substituted with an alkyl group having 1 to 8 carbon atoms such as methyl, ethyl, propyl, butyl, hexyl and octyl groups; R^{b1} represents an alkenyl group having 2 to 8 carbon atoms which is capable of reacting with a Si—H moiety in the presence of a hydrosilation catalyst; n1 and n2 each independently represents a number of the corresponding repeating units in the formula, wherein n1 is an integer of 0 or more and n2 is an integer of 1 or more; and n1+n2 is a number that provides the organopolysiloxane of formula (2) with a viscosity from 10,000 to 150,000 mPa·s at 25° C. or plasticity (mm) from 0.5 to 10.0 mm as measured according to JIS K-6249. The alkenyl content of component (A) is not specifically limited. However, the organopolysiloxane to be used as component (A) preferably has a vinyl content in the range from 0.050 to 1.50 mass %, preferably from 0.05 to 1.00 mass %, and more preferably 0.06 to 0.80 mass % relative to the total weight of the organopolysiloxane. Component (A) may be composed of one or more organopolysiloxanes of formula (2). It is also possible to use an organopolysiloxane of formula (2) with another organopolysiloxane represented by formula (1).

[Component (B)]

Component (B) is an organohydrogenpolysiloxane having silicon atom-bonded hydrogen atoms capable of reacting with the vinyl groups of component (A) in the presence of a hydrosilation catalyst. Component (B) consists of component (B1) and optionally component (B2). In other words, component (B) consists of component (B1) or a combination of component (B1) and component (B2). An important technical feature of the present invention is to use an organohydrogenpolysiloxane defined below as component (B1), which achieves the desired effects of the present invention. Therefore, the use of component (B1) as component (B) is essential in the present invention. However, the inventors have found that it is also possible to use another organohydrogenpolysiloxane as component (B2) which is different from component (B1) in addition to component (B1) without any significantly deterioration of the effects of the present invention. However, in order to achieve the effects of the present invention, it is advantageous to use component (B1) in an amount of more than 15 mass % in the total weight of component (B1) and component (B2). It is also possible to use only component (B1) as component (B). Therefore, the mass ratio of component (B1) to component (B2) ((B1)/(B2)) is preferably in the range from 100/0 to 15/85, preferably from 100/0 to 20/80, and more preferably 100/0 to 25/75.

[Component (B1)]

Component (B1) is an organohydrogenpolysiloxane having at least three silicon-bonded hydrogen atoms in each molecule and a silicon-bonded hydrogen content [Si—H]mass % satisfying the following equation:

0<[Si—H]mass %<5/(DP)^{0.5}

more preferably, 0<[Si—H]mass %<3.5/(DP)^{0.5}

wherein DP designates the average number of siloxane units in each molecule calculated by the number average molecular weight of component (B1), and the DP is in the range from 5 to 1000, preferably 5 to 500, more preferably 8 to 200, and most preferably 12 to 120. Herein, furthermore, the value of number average molecular weight of component (B1) is calculated by ²⁹Si-NMR determination of terminal Si groups and integrated value ratio of other siloxane units in the molecule. Component (B1) may be one organohydrogenpolysiloxane or a combination of two or more different organohydrogenpolysiloxanes defined above. The organohydrogenpolysiloxane used as component (B1) of the present invention has a relatively lower Si—H content per molecule compared to organohydrogenpolysiloxanes conventionally used in a curable organopolysiloxane composition to be used for a pressure-sensitive adhesive as disclosed in Patent Documents 1 to 3. The inventors of the present invention examined many different combinations of an organopolysiloxane having alkenyl groups and an organohydrogenpolysiloxane having silicon atom-bonded hydrogen atoms and unexpectedly found that when an organohydrogenpolysiloxane defined above as component (B1) is used, a curable organopolysiloxane composition comprising component (A) and component (B1) is capable of curing rapidly in the presence of a hydrosilation catalyst and that a pressure-sensitive adhesive film comprising a cured organopolysiloxane layer formed from the composition can be easily removed from a substrate to which the adhesive film is attached, without any residual materials from the cured organopolysiloxane layer remaining or only a very small acceptable amount of residual materials remaining on the surface of the substrate.

In general, the organohydrogenpolysiloxane to be used as component (B1) is represented by the following general formula:

(R^{a1}₃SiO_{1/2})ₘ₁(R^{a2}₂SiO_{2/2})ₘ₂(R^{a3}SiO_{3/2})ₘ₃ (3)

wherein R^{a1}, R^{a2}, and R^{a3} are each independently selected from the group consisting of a hydrogen atom, alkyl groups having 1 to 8 carbon atoms such as methyl, ethyl, propyl, butyl, hexyl and octyl groups, preferably a methyl group, a phenyl group, and phenyl groups substituted with an alkyl group having 1 to 8 carbon atoms or a halogen atom such as a fluorine atom, wherein at least three of the R^{a1}, R^{a2}, and R^{a3} moieties on the silicone atoms existing in the organohydrogenpolysiloxane molecule of formula (3) are hydrogen atoms. Subscripts m1, m2, and m3 each independently represents a number of the corresponding repeating unit in the molecule, where one or two of m1, m2, and m3 may be zero, but m2 and m3 are not zero at the same time, wherein R^{a1}, R^{a2}, R^{a3}, m1, m2, and m3 are selected such that the resulting organohydrogenpolysiloxane of formula (3) satisfies the following requirements: (a) the organohydrogenpolysiloxane has at least three silicon atom-bonded hydrogen atoms in each molecule, (b) the content of silicon atom-bonded hydrogen atoms in the organohydrogenpolysiloxane satisfies the following equation: 0<[Si—H] mass %<5/(DP)^{0.5}, preferably 0<[Si—H] mass %<3.5/(DP)^{0.5}, wherein DP designates the average number of siloxane units in each molecule calculated by number average molecular weight of the organohydrogenpolysiloxane, and DP is within a range from 5 to 1000, preferably 5 to 500, more preferably 8 to 300, and most preferably 8 to 100. The DP value is determined from the calculated number average molecular weight of component (B1) by ²⁹Si-NMR.

The organohydrogenpolysiloxane used as component (B1) may be a linear, a branched, or a cyclic organohydrogenpolysiloxane. An organohydrogenpolysiloxane having a linear or branched organohydrogenpolysiloxane chain, to which a cyclic organopolyhydrogensiloxane moiety is further bonded, may also be used as component (B1). Two or more same or different types of organohydrogenpolysiloxanes may be used in combination as component (B1).

An organohydrogenpolysiloxane which is most preferably used as component (B1) is a linear organohydrogenpolysiloxane represented by the following chemical formula:

(R^{a1}₂R^{b1}SiO)—[(R^{a2}HSiO_{2/2})ₙ₁(R^{a2}₂SiO_{2/2})ₙ₂]—(SiR^{a1}₂R^{b1}) (4)

wherein R^{a1} and R^{a2} each independently represents an alkyl group having 1 to 8 carbon atoms such as a methyl group, a phenyl group, or a phenyl group substituted with an alkyl group having 1 to 8 carbon atoms such as methyl, ethyl, propyl, butyl, hexyl and octyl groups, preferably a methyl group; R^{b1} independently represents a hydrogen atom, an alkyl group having 1 to 8 carbon atoms such as methyl, ethyl, propyl, butyl, hexyl and octyl groups, preferably a methyl group, a phenyl group, or a phenyl group substituted with an alkyl group having 1 to 8 carbon atoms; n1 and n2 each independently represents a number of the corresponding repeating units in the formula, wherein R^{a1}, R^{a2}, R^{b1}, n1, and n2 are selected such that the resulting organohydrogenpolysiloxane of formula (4) satisfies the following requirements: (a) the organohydrogenpolysiloxane has at least three silicon atom-bonded hydrogen atoms in each molecule, (b) the content of silicon atom-bonded hydrogen atoms in the organohydrogenpolysiloxane satisfies the following equation: 0<[Si—H] mass %<5/(DP)^{0.5}, preferably 0<[Si—H]mass %<3.5/(DP)^{0.5}, wherein DP designates the average number of siloxane units in each molecule calculated by the number average molecular weight of the organohydrogenpolysiloxane, and DP is in the a range from 5 to 1000, preferably 5 to 500, more preferably 8 to 300, and most preferably 8 to 100.

The most preferable organohydrogenpolysiloxane is represented by formula (4) shown above, wherein R^{a1} and R^{a2} each represents a methyl group, and R^{b1} represents a hydrogen atom or a methyl group, the mass % of silicon atom-bonded hydrogen atoms is in the range of from 0.15 to 1.0 mass %, and the degree of polymerization (DP) of the organohydrogenpolysiloxane is from 8 to 200, more preferably from 8 to 100. In addition, 50 mol % or more of all the terminal siloxy-groups of component (B1) may have at least one silicon-bonded hydrogen atom.

[Component (B2)]

Component (B2) is an organohydrogenpolysiloxane having at least one silicon atom-bonded hydrogen atom which is different from the organohydrogenpolysiloxane defined as component (B1). As mentioned above, the use of component (B1) is essential for the present invention. However, the inventors of the present invention found that at least a part of component (B) being the organohydrogenpolysiloxane defined as component (B1) is sufficient to produce the effects of the present invention. However, it is also possible to use only component (B1) in combination with component (A). Therefore, the use of component (B2) is optional.

An organohydrogenpolysiloxane to be used as component (B2) is in general represented by the following formula:

(R^{a1}₃SiO_{1/2})ₘ₁(R^{a2}₂SiO_{2/2})ₘ₂(R^{a3}SiO_{3/2})ₘ₃ (5)

wherein R^{a1}, R^{a2}, and R^{a3} are each independently selected from the group consisting of a hydrogen atom, alkyl groups having 1 to 8 carbon atoms such as methyl, ethyl, propyl, butyl, hexyl and octyl groups, preferably a methyl group, a phenyl group, and phenyl groups substituted with an alkyl group having 1 to 8 carbon atoms or a halogen atom such as a fluorine atom, wherein at least one of R^{a1}, R^{a2}, and R^{a3} moieties on the silicone atoms of the organohydrogenpolysiloxane molecule of formula (5) is a hydrogen atom. Subscripts m1, m2, and m3 each independently represents a number of the corresponding repeating unit in the molecule, where one or two of m1, m2, and m3 may be zero, but m2 and m3 are not zero at the same time. Most preferably, R¹, R^{a2}, and R^{a3} are each independently selected from the group consisting of a hydrogen atom and a methyl group. The organohydrogenpolysiloxane of formula (5) is different from the organohydrogenpolysiloxane which is used as component (B1) and represented by formula (3). Therefore, the organohydrogenpolysiloxane of formula (5), which is used as component (B2), has only one or two hydrogen atoms in each molecule, or the organohydrogenpolysiloxane used as component (B2) does not satisfy the following equation:

0<[Si—H]mass %<5/(DP)^{0.5}

which is as defined above for component (B1), and thus the value 5/(DP)^{0.5} of component (B2) is equal to or smaller than the [Si—H] mass % of the organohydrogenpolysiloxane used as component (B2); or the DP is out of the range from 5 to 1000.

The organohydrogenpolysiloxane used as component (B2) may be a linear, a branched, or a cyclic organohydrogenpolysiloxane. An organohydrogenpolysiloxane having a linear or branched organohydrogenpolysiloxane chain, to which a cyclic organopolyhydrogensiloxane moiety is further bonded, may also be used as component (B2). Two or more same or different types of organohydrogenpolysiloxanes may be used in combination as component (B2).

When component (B2) is used, the amount of component (B2) used in the curable organopolysiloxane composition should be adjusted to ensure that the desired effects of the present invention are still achieved.

[Component (C)]

Component (C) is a catalyst for the hydrosilation reaction between the silicon atom-bonded hydrogen atoms of component (B) and the alkenyl groups of component (A) to promote the addition reaction between a Si—H group and an alkenyl group such as a vinyl group. Any type of hydrosilation catalysts which are known in the art may be used for the present invention. As examples of a hydrosilation catalyst which may be used, mention may be made of platinum compounds such as chloroplatinic acid, alcohol-modified chloroplatinic acid, chloroplatinic acid/olefin complexes, chloroplatinic acid/ketone complexes, platinum/alkenylsiloxane complexes, platinum tetrachloride, platinum micropowder, solid platinum supported on a support such as alumina powder or silica powder, platinum black, olefin complexes of platinum, carbonyl complexes of platinum, and a powdery thermoplastic resin (e.g., methyl methacrylate resin, polycarbonate resin, polystyrene resin, silicone resin, and so forth) that incorporates one or more of the aforementioned platinum compounds.

Other examples of hydrosilation catalysts are rhodium compounds such as [Rh(O₂CCH₃)₂]₂, Rh(O₂CCH₃)₃, Rh₂(C₈H₁₅O₂)₄, Rh(C₅H₇O₂)₃, Rh(C₅H₇O₂)(CO)₂, Rh(CO)[Ph₃P](CH₇O₂), RhX₃[(R₆)₂S]₃, (R₇₃P)₂Rh(CO)_{X}, (R₇₃P)₂Rh(CO)H, Rh₂X₂Y₄, HₐRh_{b}(E)_{c}Cl_{d}, and Rh[O(CO)R₃]₃₋ₙ(OH)ₙ, wherein X is a hydrogen atom, chlorine atom, bromine atom, or iodine atom; Y is an alkyl, CO, or C₈H₁₄ group; R₆ is an alkyl, cycloalkyl, or aryl group; R₇ is an alkyl, aryl, alkyloxy, or aryloxy group, E is an olefin; a is 0 or 1; b is 1 or 2; c is an integer from 1 to 4; d is 2, 3, or 4; and n is 0 or 1; and iridium compounds such as Ir(OOCCH₃)₃, Ir(C₅H₇O₂)₃, [Ir(Z)(E)₂]₂, and [Ir(Z)(Dien)]₂, wherein Z is a chlorine atom, a bromine atom, an iodine atom, or an alkoxy group; E is an olefin; and Dien is cyclooctadiene.

Due to their high catalytic activities, chloroplatinic acid, platinum/vinylsiloxane complexes, and olefin complexes of platinum are preferably used as component (C). The chloroplatinic acid/divinyltetramethyldisiloxane complex, chloroplatinic acid/tetramethyttetravinylcyclotetrasiloxane complex, and platinum/alkenylsiloxane complexes, e.g., platinum/divinyltetramethyldisiloxane complex, platinum/tetramethyltetravinylcyclotetrasiloxane complex, and the like, are particularly preferred for use as component (C) of the present invention.

Component (C) is added to the other components in a catalytic amount that is sufficient to cause the hydrosilation reaction between component (A) and component (B) to proceed. The amount of component (C) to be incorporated into the curable organopolysiloxane composition of the present invention is in general 1 to 1,000 ppm, and preferably 5 to 500 ppm as the amount of metal contained in component (C) relative to the total weight of the curable composition.

Optionally, an agent which retards (inhibits) a hydrosilation reaction may be added to the curable organopolysiloxane composition in order to control the reaction rate and improve storage stability of the composition. As such an agent of hydrosilation reaction inhibitor, mention may be made of acetylenic compounds, ene-yne compounds, organonitrogen compounds, organophosphorus compounds, and oxime compounds. Specific examples of such an agent include alkynyl alcohols such as 3-methyl-1-butyn-3-ol, 3,5-dimethyl-1-hexyn-3-ol, 3-methyl-1-pentyn-3-ol, phenylbutynol, and so forth; and 3-methyl-3-penten-1-yne, 3,5-dimethyl-1-hexyn-3-ene, benzotriazole, 1-ethynyl-1-cyclohexanol, and methylvinylcyclosiloxanes. The amount of such an agent to be added to the curable organopolysiloxane composition is generally in the range from 0.001 to 5 parts by weight, and preferably from 0.01 to 2 parts by weight per 100 parts by weight of component (A), but not limited thereto.

[Optional Additives-MT Resins and MQ Resins]

If desired, the curable organopolysiloxane composition of the present invention may further comprise an organopolysiloxane resin comprising R₃SiO_{0.5} units and at least one of RSiO_{1.5} units and SiO_{2.0} units, wherein R independently represents a monovalent organic group, hydroxyl group or alkoxy group, in particular a monovalent hydrocarbon group such as an alkyl group having 1 to 8 carbon atoms and a phenyl group, preferably a methyl group, and the content of the organopolysiloxane resin in the composition is less than 40 mass %, preferably less than 20 mass %, and most preferably less than 10 mass % of the total amount of the solid components of the curable organopolysiloxane composition. The adhesive strength of a cured organopolysiloxane composition prepared from the curable organopolysiloxane composition of the present invention may be increased by the addition of the aforementioned silicone resin, in particular a MQ resin. Specific examples of these silicone resins are known as a MT resin or a MQ resin. Incorporating one of these silicone resins, in particular a MQ resin, may improve the adhesive strength of the cured organopolysiloxane composition to a substrate, and thus these resins are preferably used as an additive to the curable organopolysiloxane composition of the present invention. However, in order to maintain good releasing properties of the cured organopolysiloxane composition, it is preferable to use one or more of these silicone resins, in particular a MQ resin, in an amount of less than 40 mass %, preferably less than 20 mass %, and more preferably less than 10 mass % of the total amount of the solid components of the curable organopolysiloxane composition.

For the curable organopolysiloxane composition of the present invention described above, it is particularly preferable to use, as component (A), a linear organopolysiloxane having at least two alkenyl groups in each molecule with an alkenyl content in a range from 0.005 to 1.50 mass %, which is represented by formula (2) described above. This linear organopolysiloxane is referred to as component (A1). In combination with component (A1), it is particularly preferable to use, as component (B), a linear organohydrogenpolysiloxane having at least three silicon atom-bonded hydrogen atoms, wherein the average number (DP) of siloxane units in each molecule calculated from the number average molecular weight is in the range from 8 to 300, preferably 8 to 100, and 50 mol % or more of all the terminal siloxy-groups have at least one silicon-bonded hydrogen atom; and the following equation is satisfied: 0<[Si—H]mass %<3.5/(DP)^{0.5}, wherein the [Si—H] mass % and DP are as defined above. The aforementioned component (B1) is referred to as component (B1′). In addition, the curable organopolysiloxane composition comprising components (A1), (B1′), and (C) may further comprise the aforementioned organopolysiloxane resin comprising R₃SiO_{0.5} units and at least one of RSiO_{1.5} units or SiO_{2.0} units, wherein R each independently represents a monovalent organic group, hydroxyl group or alkoxy group, in particular a monovalent hydrocarbon group such as an alkyl group having 1 to 8 carbon atoms and a phenyl group, and preferably a methyl group in an amount equal to or less than 20 mass %, and preferably in an amount equal to or less than 10 mass % of the total weight of the solid components contained in the curable organopolysiloxane composition. Accordingly, one preferable embodiment of the curable organopolysiloxane compositions of the present invention is a curable composition comprising component (A1), component (B1′), and component (C), without comprising any of the aforementioned organopolysiloxane resins. Furthermore, it is also possible to use a combination of component (B1′) and component (B2) as component (B) in the cured organopolysiloxane composition described above.

[Other Optional Additives]

If desired, other optional additives may be added to the curable organopolysiloxane composition of the present invention. As optional additives which may be used, mention may be made of an organic solvent such as a hydrocarbon solvent, for instance toluene and xylene; Adhesion promoters, such as epoxy-functional silanes, Non-reactive polyorganosiloxanes, such as polydimethylsiloxane and polydimethyl diphenylsiloxane to provide slippery surface; Antioxidant, such as a phenol type, a quinone type, an amine type, a phosphorus type, a phosphite type, a sulfur type, and a thioether type compound; Photostabilizers, such as a triazole type compound and a benzophenone type compound; Flame retardants/Heat-resisting additives, such as a phosphate ester type, a halogen type, a phosphorus type, and an antimony type compound; One or more types of antistatic agent consisting of cationic surfactant, anionic surfactant, nonionic surfactant, etc.; Dyes, Pigments, or Other inorganic fillers etc. In particular, addition of an antistatic agent is preferable.

The amount of a solvent which may be incorporated into the curable composition of the present invention is preferably equal to or less than 5 mass %, and more preferably equal to or less than 1 mass % of the total weight of the composition.

In other embodiments of the invention, the curable organopolysiloxane composition is solventless.
The curable organopolysiloxane composition can be used in the form of an emulsion, typically an oil-in-water emulsion containing the curable organopolysiloxane composition as defined above, a surfactant and water.

[Adhesive Properties of a Cured Organopolysiloxane Composition]

The adhesive strength of a cured organopolysiloxane prepared from the curable organopolysiloxane composition of the present invention to a substrate on which the cured organopolysiloxane is attached can be controlled by designing the molecular structures of component (A) and component (B) appropriately. For example, but not limited, the adhesive strength can be controlled to some extent by i) adding an organopolysiloxane resin as sticky substance on the surface, ii) adjusting the reaction ratio of SiH/Si-Vi group ratio to design the cross-linking density of the cured body or intentionally remain reactive groups on the surface to increase the adhesiveness; or iii) using organopolysiloxane with low/high mass % of Vi group or having Si-bonded Vi group on side chain/terminal positions in the siloxane polymer to effect the adhesive property of the cured body.

It is preferred to adjust the adhesive strength of a cured organopolysiloxane composition of the present invention on a substrate such that when a cured layer having a thickness of 30 μm is formed from the composition on a polyethylene terephthalate film having a thickness of 75 μm, the adhesive strength of the cured layer to the film is in the range from 0.5 to 20.0 gf/25 mm, and preferably from 0.5 to 15.0 gf/25 mm as measured according to the 180-degree peel test method specified in the Japanese Industrial Standards Z 0237. The polyethylene terephthalate film is not specifically limited, but a standard polyethylene terephthalate film is preferable and commercially available from TOYOBO as product name A4300 series with thickness of 75 μm.

When an organopolysiloxane resin composed of R₃SiO_{0.5} units and at least one of RSiO_{1.5} units or SiO_{2.0} units is incorporated into the curable organopolysiloxane composition of the present invention, it is preferred to adjust the adhesive strength of a cured organopolysiloxane composition of the present invention on a substrate such that when a cured layer having a thickness of 30 μm is formed from the composition on a polyethylene terephthalate film having a thickness of 75 μm, the adhesive strength of the cured layer to the film is in the range from 0.5 to 15.0 gf/125 mm, preferably 0.5 to 10.0 gf/25 mm, as measured according to the 180-degree peel test method specified in the Japanese Industrial Standards Z 0237. Regarding the polyethylene terephthalate film, as shown in preceding paragraph, TOYOBO's A4300 series with thickness of 75 μm is available.

By designing the formulation of a curable organopolysiloxane composition such that the cured composition provides the adhesive strength defined above, the resulting pressure-sensitive adhesive can be easily and rapidly removed from a substrate with no residues or only an acceptable small amount of residues derived from the adhesive remaining on the surface of the substrate. This feature is useful when the pressure-sensitive adhesive is used for a protective film which is used temporarily protect a substrate such as a glass sheet.

[Applications of the Curable Organopolysiloxane Composition]

As described above, the curable organopolysiloxane composition of the present invention is preferably used for preparing a pressure-sensitive adhesive. Therefore, the present invention also relates to a pressure-sensitive adhesive (PSA) composition consisting of a cured composition prepared from the curable organopolysiloxane composition of the present invention. The curable composition of the present invention is also useful as a rapid curing coating composition, a primer composition for other release coatings or adhesive layers, an adhesive composition other than that used for a pressure-sensitive adhesive composition, or a coating composition such as a release coating composition. In particular, since the cured composition prepared from the curable organopolysiloxane composition of the present invention may be easily removed from a material to which the cured composition is attached, the curable composition of the present invention is preferably used as a release coating composition.

The present invention also relates to an article which comprises a layer of cured organopolysiloxane composition prepared from the curable organopolysiloxane composition of the present invention. One example of the article is a laminate which comprises a substrate such as a base film and a layer of cured organopolysiloxane composition prepared by curing the curable organopolysiloxane composition of the present invention, where the layer of cured organopolysiloxane is an adhesive layer, in particular a pressure-sensitive adhesive layer, a release coating layer, or a primer layer. These laminates include a protective film, for instance a protective film used for a polarizer, a light guide plate, a phase difference film, an optical film or sheet used for an LCD, a base film for a touch panel, an anti-reflection film for a display, an anti-glare film, an optical element, a steel plate which is used, for example, in automotive industries, or a plastic sheet or element. Therefore, the present invention also provides a protective film comprising the laminate described above. In addition, the present invention provides an optical article comprising the laminate described above. As such an optical article, mention may be made of a light-diffusion film, a polarizer, a light guide plate, a phase difference film, anti-glare film and the like.

When the curable organopolysiloxane composition of the present invention is used for a protective film which is used to temporarily protect the surface of an article such as a glass sheet, it is advantageous to use a plastic film which has been subjected to a treatment for increasing the adhesive properties of the film surface to a layer of cured organopolysiloxane formed from the curable organopolysiloxane composition of the present invention. By using such a plastic base film, it is possible to ensure that the cured organopolysiloxane layer does not separate from the surface of the base film, but does separate from the surface of an article to be protected by the protective film. Methods for improving the adhesive properties of a plastic film are widely known, and include a corona treatment, a plasma treatment, an application of a material capable of improving the adhesive properties of a plastic film to the surface thereof, and the like. As such a material which is applied to the surface of a plastic film to improve the adhesive properties thereof, mention may be made of a polyester resin, a polyurethane resin, a polyacrylate resin, a polyvinylalcohol resin or a polyvinyl alcohol copolymer, and an ethylene-vinyl acetate copolymer resin. Instead of using a plastic film, a cellulosic material such as a paper may be used as a base material of a protective film to which the curable polyorganosiloxane composition of the present invention is applied to form a layer of a cured organopolysiloxane composition.

A laminate, such as a protective film, comprising a sheet-form substrate and a layer of a cured organopolysiloxane composition prepared from the curable organopolysiloxane composition of the present invention may be prepared by using a conventional method for coating a fluid material to a substrate in the form of a sheet. One of the preferred methods for preparing the laminate is a method comprising a step of applying the curable organopolysiloxane composition of the present invention to at least one side of a sheet-form substrate. The curable organopolysiloxane composition can be applied by gravure coater, offset coater, offset-gravure coater, roller coater (incl. a multiple-roll coater such as a two-roll coater and a three-roll coater), reverse-roller coater, air-knife coater, curtain coater, or a comma coater. The coated curable organopolysiloxane composition is then cured, for example by heating, for example under a temperature of 70 to 220° C. to prepare a laminate comprising a sheet-form substrate and a layer of a cured organopolysiloxane composition.

The invention also extends to the use of an organohydrogenpolysiloxane having at least three silicon-bonded hydrogen atoms in each molecule and a silicon-bonded hydrogen content [Si—H] mass % satisfying the following equation:

0<[Si—H]mass %<5/(DP)^{0.5}
wherein DP designates the average number of siloxane units in each molecule calculated by the number average molecular weight of component (B1), and said DP is in the range from 5 to 1000;
   as a component of a curable organopolysiloxane composition curable by hydrosilation, for example a curable organopolysiloxane composition as defined above, for example as a component of a PSA (pressure-sensitive adhesive) composition as defined above.

### EXAMPLES

The present invention is further explained in details with reference to the following examples. However, the present invention should not be limited to these examples.

[A General Procedure for Preparing a Curable Organopolysiloxane Composition]

A solution of a curable organopolysiloxane composition was prepared by mixing the following components (i) to (iii),

(i) 100 parts by weight of a 30 mass % solution of a dimethylsiloxane/methylvinylsiloxane copolymer (unvulcanized rubber 1 as component A, which has a plasticity value of 160 and 0.22 mass % of vinyl groups) in toluene, wherein the copolymer had a dimethylvinylsiloxy group at each end of the copolymer chain and vinyl groups on some of the Si atoms at the internal part of the copolymer chain,
(ii) an organohydrogenpolysiloxane as component B1 in such an amount that the molar ratio of the SiH groups of the organohydrogenpolysiloxane (Si—H)/the alkenyl groups of component A (Vi) is 4, and
(iii) 0.3 parts by weight of 1-ethynyl-1-cyclohexanol.
1,1,3,3-tetramethyldisiloxane platinum complex was added to the resulting mixture, in such an amount that platinum metal is 50 ppm by weight relative to the amount of the dimethylsiloxane/methylvinylsiloxane, to obtain a solution of a curable organopolysiloxane composition which may be used as a pressure sensitive adhesive.

[A General Procedure for Evaluating a Cured Product Prepared from the Curable Organopolysiloxane Composition as a Pressure Sensitive Adhesive Composition]

The solution of a curable organopolysiloxane composition, which was obtained by using the procedure described above, was applied to the surface of a polyethyleneterephthalate film (PET film, product name: A4300 from TOYOBO, Co., Ltd.) having a thickness of 75 micrometers and having improved adhesive properties by means of an applicator, and the curable composition was dried and cured by heating at 140° C. for 2 minutes to prepare a pressure-sensitive adhesive film which has a pressure-sensitive adhesive layer with 30 micrometers thickness. Two sheets of 3×4 cm size were prepared from the pressure-sensitive adhesive film, and one of the two sheets was attached to one side of a glass sheet with a thickness of 0.5 mm, and the other of the two sheets was attached to the other side of the glass sheet by using a roller which has a weight of 2 kg. After storing in an oven under the conditions of 95% relative humidity at 80° C. for 24 hours, the test sample was taken out of the oven and cooled to room temperature. The two pressure-sensitive adhesive films attached on the surface of the glass sheet were peeled off, and visual inspection was conducted to check whether the adhesive composition or some materials contained in the composition remained on the surface of the glass sheet under conditions wherein the incident angle of light from a LED flashlight relative to the surface of the glass sheet is 45 degrees and the light comes from the back side of the glass sheet. The results are summarized in Table 2 below (please refer to “Migration” in the table).

### Examples 1 to 21

According to the general procedures described above, curable pressure-sensitive adhesive compositions were prepared and evaluated as shown in Table 2. Component A is the organopolysiloxane having vinyl groups as described above, and components B1 used in the examples are as shown in Table 1 below.

TABLE 1
B1 component (Cross-linking Silicone (XL) No. 1 to 16) used in
the examples

| | | Terminal | Side | Total | | [SiH] | |
|---|---|---|---|---|---|---|---|
| XL No | DP (*2) | Si—H (*1) | SiH (*1) | SiH (*1) | Mn (*1) | (mass %) (*2) | 5/(DP^{0.5}) |
| 1 | 18.4 | 2 | 5 | 7 | 832 | 0.81 | 1.17 |
| 2 | 22.5 | 1.8 | 5 | 6.8 | 1572 | 0.44 | 1.05 |
| 3 | 60.8 | 2 | 5 | 7 | 4162 | 0.17 | 0.64 |
| 4 | 113.1 | 2 | 12 | 14 | 8282 | 0.17 | 0.47 |
| 5 | 58.8 | 2 | 12 | 14 | 4062 | 0.34 | 0.65 |
| 6 | 11.5 | 0 | 6 | 6 | 892 | 0.78 | 1.47 |
| 7 | 28.0 | 0 | 12.5 | 12.5 | 1689 | 0.75 | 0.95 |
| 8 | 11.8 | 0 | 2.85 | 2.85 | 987.9 | 0.34 | 1.46 |
| 9 | 58.0 | 0 | 7 | 7 | 4134 | 0.16 | 0.66 |
| 10 | 133.5 | 0 | 18 | 18 | 8642 | 0.21 | 0.43 |
| 11 | 98.6 | 2 | 40 | 42 | 5506 | 0.76 | 0.50 |
| 12 | 18.0 | 0 | 16 | 16 | 1122 | 1.42 | 1.18 |
| 13 | 71.2 | 0 | 30 | 30 | 4034 | 0.71 | 0.59 |
| 14 | 53.7 | 0 | 50 | 50 | 3162 | 1.58 | 0.68 |
| 15 | 56.9 | 0 | 44 | 44 | 3986 | 1.04 | 0.66 |
| 16 | 75.8 | 0 | 50 | 50 | 4716 | 1.03 | 0.57 |

*(1) These values, which indicate average numbers of silicon atom-bonded hydrogen atoms (Si—H) per molecule or number-average molecular weights (Mn), were calculated from ²⁹Si NMR of B1.
*(2) DP and SiH % for XL were measured and calculated from ²⁹Si NMR and summarized in the table.

TABLE 2

| | | | B1 Component (XL) | | | | | C = C PDMS | | |
|---|---|---|---|---|---|---|---|---|---|---|
| Example | | B1 (XL) | XL | DP | [SiH] | | | Alkenyl | Plasticity | Vinyl |
| No. | | No. | Type (*1) | value (*8) | mass % (*8) | 4/(DP^{0.5}) | 5/(DP^{0.5}) | group (*2) | (mm) | wt % |
| Practical examples | 1 | 1 | A | 18.4 | 0.81 | 0.93 | 1.17 | Vi | 1.6 | 0.22% |
| | 2 | 2 | A | 22.5 | 0.44 | 0.84 | 1.05 | Vi | 1.6 | 0.22% |
| | 3 | 3 | A | 60.8 | 0.17 | 0.51 | 0.64 | Vi | 1.6 | 0.22% |
| | 4 | 4 | A | 113.1 | 0.17 | 0.38 | 0.47 | Vi | 1.6 | 0.22% |
| | 5 | 5 | A | 58.8 | 0.34 | 0.52 | 0.65 | Vi | 1.6 | 0.07% |
| | 6 | 6 | B | 11.5 | 0.78 | 1.18 | 1.47 | Vi | 1.6 | 0.22% |
| | 7 | 7 | B | 28.0 | 0.75 | 0.76 | 0.95 | Vi | 1.6 | 0.22% |
| | 8 | 8 | B | 11.8 | 0.34 | 1.17 | 1.46 | Vi | 1.6 | 0.22% |
| | 9 | 9 | B | 58.0 | 0.16 | 0.53 | 0.66 | Vi | 1.6 | 0.22% |
| | 10 | 10 | B | 133.5 | 0.21 | 0.35 | 0.43 | Vi | 1.6 | 0.22% |
| Comparative | 11 | 11 | A | 98.6 | 0.76 | 0.40 | 0.50 | Vi | 1.6 | 0.22% |
| examples | 12 | 12 | B | 18.0 | 1.42 | 0.94 | 1.18 | Vi | 1.6 | 0.22% |
| | 13 | 13 | B | 71.2 | 0.71 | 0.47 | 0.59 | Vi | 1.6 | 0.22% |
| | 14 | 14 | B | 53.7 | 1.58 | 0.55 | 0.68 | Vi | 1.6 | 0.22% |
| | 15 | 15 | B | 56.9 | 1.04 | 0.53 | 0.66 | Vi | 1.6 | 0.22% |
| | 16 | 16 | B | 75.8 | 1.03 | 0.46 | 0.57 | Vi | 1.6 | 0.22% |
| Practical Examples | 17 | 5 | A | 58.8 | 0.34 | 0.52 | 0.65 | Hex | 1.3 | 0.25% |
| | 18 | 2 | A | 22.5 | 0.44 | 0.84 | 1.05 | Vi | 1.6 | 0.22% |
| | 19 | 2 | A | 22.5 | 0.44 | 0.84 | 1.05 | Vi | 1.6 | 0.22% |
| | 20 | 3/15(75:25) | A/B | — | — | | — | Vi | 1.6 | 0.22% |
| | 21 | 3/15(75:25) | A/B | — | — | | — | Vi | 1.6 | 0.22% |

| | | | SiH/Vi | | | | |
|---|---|---|---|---|---|---|---|
| Example | | B1 (XL) | (molar | MQ | base | | |
| No. | | No. | ratio) | resin (*3) | film (*4) | Adhesion (*7) | Migration (*5) |
| Practical examples | 1 | 1 | 4 | 0 wt % | Toyo | 2 | S |
| | 2 | 2 | 4 | 0 wt % | Toyo | 2 | S |
| | 3 | 3 | 4 | 0 wt % | Toyo | 2 | S |
| | 4 | 4 | 4 | 0 wt % | Toyo | 2 | A |
| | 5 | 5 | 8 | 0 wt % | Toyo | 3 | S |
| | 6 | 6 | 4 | 0 wt % | Toyo | 3 | A |
| | 7 | 7 | 4 | 0 wt % | Toyo | 1 | B |
| | 8 | 8 | 4 | 0 wt % | Toyo | 1 | A |
| | 9 | 9 | 4 | 0 wt % | Toyo | 2 | A |
| | 10 | 10 | 4 | 0 wt % | Toyo | 2 | A |
| Comparative | 11 | 11 | 4 | 0 wt % | Toyo | 1 | C |
| examples | 12 | 12 | 4 | 0 wt % | Toyo | 1 | C |
| | 13 | 13 | 4 | 0 wt % | Toyo | 1 | C |
| | 14 | 14 | 4 | 0 wt % | Toyo | 2 | D |
| | 15 | 15 | 4 | 0 wt % | Toyo | 1 | D |
| | 16 | 16 | 4 | 0 wt % | Toyo | 1 | D |
| Practical Examples | 17 | 5 | 8 | 0 wt % | Toyo | 3 | S |
| | 18 | 2 | 4 | 0 wt % | Primer | 2 | S |
| | 19 | 2 | 4 | 5 wt % | Toyo | 2 | S |
| | 20 | 3/15(75:25) | 4 | 0 wt % | Toyo | 2 | S |
| | 21 | 3/15(75:25) | 4 | 0 wt % | Toyo | 2 | B |

(*1): Type A indicates that component B1 has Si—H groups at both the terminal and non-terminal Si atoms. Type B indicates that component B1 has Si—H groups only at the non-terminal Si atoms.
(*2): Vi represents vinyl groups. Hex indicates a 1-hexenyl group.
(*3): An amount of MQ resin in the total weight of the composition.
(*4): “Toyo” means that a PET film (A4300) having good adhesive properties manufactured by TOYOBO Co. Ltd. was used as a substrate.
“Primer” indicates that a primer was applied to the surface of the substrate film before applying a curable organopolysiloxane pressure-sensitive composition.
(*5): S, A, B, C, or D, which was measured as described below, indicates the degree of migration of materials from the cured organopolysiloxane layer to the surface of the glass sheet. The degree of migration of materials from the cured organopolysiloxane layer to the surface of a glass sheet was observed after the laminate composed of a PET film (A4300 from TOYOBO) and a cured organopolysiloxane layer was removed from the glass sheet.
(*6): “Plasticity” was measured according to JIS K-6249.
(*7): Adhesion (9/25 mm): the adhesion force was measured according to the following method: PSA film of 25 mm × 20 cm was prepared and attached to a glass plate (70 mm × 150 mm × 2.0 mm) by using a roller which has a weight of 2 kg. After storing it at 25° C. or 24 hours adhesion was measured by the 180-degree peel test method specified in the Japanese Industrial Standards Z 0237.
(*8): DP and SiH % for XL (B1 component) were measured and calculated from ²⁹Si NMR and summarized in the table.

The results obtained in the examples are also classified into the following five categories according to the following criteria:

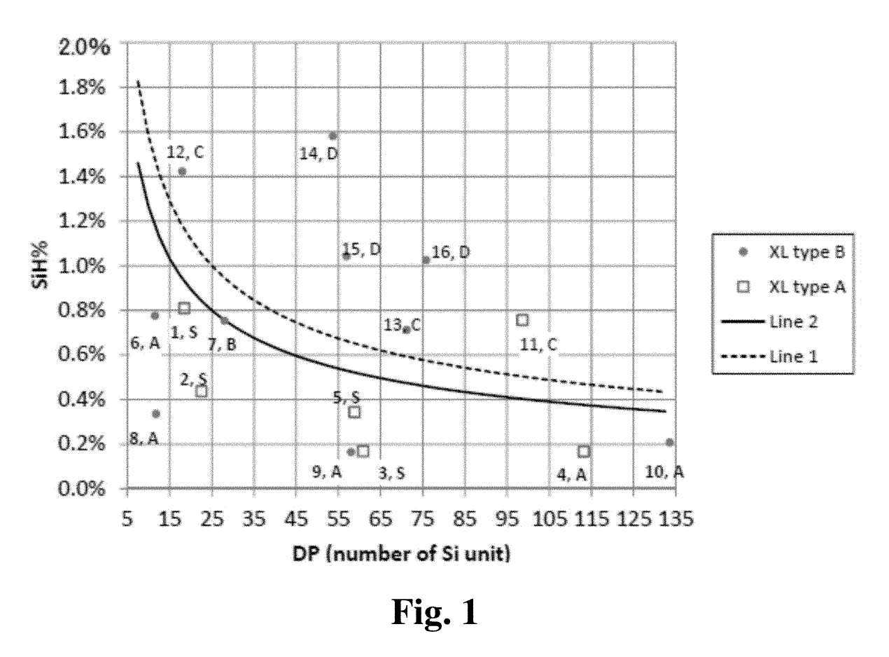

S: Similar to blank glass with an LED flash light
A: Very slightly visible with an LED flash light but invisible with fluorescent light
B: Slightly visible with an LED flash light but invisible with fluorescent light
---------the border of acceptability in the amount of residue-------------
C: Visible with an LED flash light and slightly visible with fluorescent light
D: Visible under fluorescent ceiling light.
The results are shown as S, A, B, C, or D in Table 2 as “Migration”, which are also shown in FIG. 1. In FIG. 1, the degree of migration, S, A, B, C, or D for each sample is indicated together with the sample number.

Two lines are also added to FIG. 1, where each line shows that a [Si—H] mass % of component B1 is equal to 5/(DP)^{0.5} (Line 1) or 3.5/(DP)^{0.5} (Line 2) respectively. It can be understood from FIG. 1 that when a [Si—H] mass % of component B1 satisfies the following equation: 0<[Si—H] mass %<5/(DP)^{0.5}, preferably 0<[Si—H] mass %<3.5/(DP)^{0.5}, no residual materials of the resulting pressure-sensitive adhesive composition or only an acceptable small amount of residual materials remained on the surface of a substrate after the pressure-sensitive adhesive composition was removed from the surface. Herein the acceptable amount standard is defined as above “B” or higher criteria (“A” to “S”). Therefore, it is understood from these experimental data that the pressure sensitive-adhesive composition of the present invention can cure rapidly and even after removing the adhesive composition from the surface of a substrate, no or only a very small and acceptable amount of residues remains on the surface of the substrate.

### [Example 1] Composition A

Composition A comprising a solvent was prepared by uniformly mixing the following components (A), (C), (E), and (F):

(A) a1) 30.0 parts by weight of a polydimethylsiloxane having hexenyl groups at both the terminals of the molecular chain and also as a side chain, which has a plasticity of 1.18 and a vinyl content (Vi) of 0.80 mass % calculated based on the amount of the part of —CH═CH₂ of the hexenyl groups;
(C) 2.0 parts by weight of B1 (XL) No. 16 shown in Table 2, which is a dimethylpolysiloxane-methylhydrogenpolysiloxane copolymer having a trimethylsiloxy group at both of the terminals of the molecular chain, which is an amount such that the molar ratio of SiH/Vi in the total composition is 2.3;
(E) 70.0 parts by weight of toluene; and
(F) 1.0 parts by weight of 3-methyl-1-butyn-3-ol.
Composition A thus obtained was diluted with (E) a mixture of toluene and hexane (50/50 wt %) to adjust the solid content of the composition to 3.0 mass %. To this mixture, (D) chloroplatinic acid/1,3-divinyl-1,1,3,3-tetramethyldisiloxane complex (a platinum metal content is 0.6 mass %) was added in an amount such that the platinum metal content in the total of the resulting composition is 120 ppm, and mixed them to prepare a curable organopolysiloxane composition comprising a solvent. The resulting composition was applied to the surface of a biaxially-drawn polyethyleneterephthalate film having a thickness of 38 μm (manufactured by Mitsubishi Plastics, Inc.) in an amount of 0.15 g/m² by using a Meyer bar (No. 4), followed by heating at 90° C. for 15 seconds or at 100° C. for 30 seconds to obtain a cured release coating layer in the form of a thin film. Properties of the cured composition are shown in Table 3 below. In Table 3, “OK” means that the film was sufficiently cured, and “NG” means that when the film was strongly rubbed with a finger, it came off.

### [Example 2] Composition B

Composition B was prepared similarly to the preparation of Composition A, excepting that 4.66 parts by weight of B1 (XL) No. 2 shown in Table 2 was used instead of 2.0 parts by weight of B1 (XL) No. 16, and also used 64.34 parts by weight of toluene instead of 70.0 parts by weight of toluene. The curing properties of Composition B were evaluated. The results are shown in Table 3.

### [Example 3] Composition C

Composition C was prepared similarly to the preparation of Composition A, excepting that 5.89 parts by weight of B1 (XL) No. 5 shown in Table 2 was used instead of 2.0 parts by weight of B1 (XL) No. 16, and also used 63.11 parts by weight of toluene instead of 70.0 parts by weight of toluene. The curing properties of Composition C were evaluated. The results are shown in Table 3.

TABLE 3

| Curability | | A | B | C |
|---|---|---|---|---|
| Cure | 90° C., 15 s | NG | OK | OK |
| condition | 100° C., 30 s | OK | OK | OK |

It can be understood from the results shown in Table 3 that the release coating compositions of the present invention exhibit good and sufficient curability at a relatively low temperature and in a short period of time.

### [Example 1-2] Composition A′

Composition A, an organopolysiloxane composition, was prepared as described in Example 1. Composition A was diluted with toluene to adjust the solid content thereof to 5.0 mass %. To the resulting diluted composition, (D) chloroplatinic acid/i 1,3-divinyl-1,1,3,3-tetramethyldisiloxane complex (the content of platinum metal is 0.6 mass %) was added in an amount such that the amount of platinum metal is 60 ppm in the total composition, and a curable composition A′ was prepared. The resulting composition was applied to the surface of a sheet of high quality paper laminated with polyethylene (manufactured by Lintec, Inc.) in an amount of 1.0 g/m² by using a Meyer bar (No. 8), followed by heating at 100° C. for 15 seconds or at 110° C. for 15 seconds to obtain a cured coating layer in the form of a thin film. Curing properties of the composition are shown in Table 4 below. In Table 4, “OK” means that the film was sufficiently cured, and “NG” means that when the film was strongly rubbed with a finger, it came off.

### [Example 2-2] Composition B′

Composition B′ was prepared similarly to the preparation of Composition A′, excepting that 4.66 parts by weight of B1 (XL) No. 2 shown in Table 2 was used instead of 2.0 parts by weight of B1 (XL) No. 16, and also used 64.34 parts by weight of toluene instead of 70.0 parts by weight of toluene. The curing properties of Composition B′ were evaluated. The results are shown in Table 4 below.

### [Example 3-2] Composition C′

Composition C′ was prepared similarly to the preparation of Composition A′, excepting that 5.89 parts by weight of B1 (XL) No. 5 shown in Table 2 was used instead of 2.0 parts by weight of B1 (XL) No. 16, and also used 63.11 parts by weight of toluene instead of 70.0 parts by weight of toluene. The curing properties of Composition C′ were evaluated. The results are shown in Table 4 below.

TABLE 4

| Curability | | A′ | B′ | C′ |
|---|---|---|---|---|
| Cure | 100° C., 15 s | NG | OK | OK |
| condition | 110° C., 15 s | OK | OK | OK |

Each of the compositions of the present invention exhibited good curability at a relatively low temperature and in a short period of time even after it was diluted with toluene.

### INDUSTRIAL APPLICABILITY

The curable organopolysiloxane composition of the present invention may be used for any application in which a curable organopolysiloxane composition can be used, such as a coating material, an adhesive composition, and in particular a pressure-sensitive adhesive composition, a release coating, and a primer. Among these applications, the composition of the present invention is particularly useful as a pressure-sensitive adhesive composition, especially as a pressure-sensitive adhesive composition used to form the adhesive layer of a protective film which is used for protecting a surface of an article such as a sheet of glass, where the film may be used temporarily and removed before the protected article is used in a subsequent step.

1. A curable organopolysiloxane composition comprising:
(A) an organopolysiloxane having at least two alkenyl groups in each molecule;
(B) an organohydrogenpolysiloxane in an amount sufficient to provide a value of 1.1:1 to 20:1 (Si—H:alkenyl group) for the molar ratio of silicon-bonded hydrogen atoms in the organohydrogenpolysiloxane to the alkenyl groups in component (A), wherein component (B) consists of the following components (B1) and (B2) at a mass ratio of (B1)/(B2) in the range from 100/0 to 15/85:
(B1) an organohydrogenpolysiloxane having at least three silicon-bonded hydrogen atoms in each molecule and a silicon-bonded hydrogen content [Si—H] mass % satisfying the following equation:
0<[Si—H]mass %<5/(DP)^{0.5}
wherein DP designates the average number of siloxane units in each molecule calculated by the number average molecular weight of component (B1), and the DP is in the range from 5 to 1000;
(B2) an organohydrogenpolysiloxane having at least one silicon-bonded hydrogen atom in each molecule, which is different from component (B1); and
(C) a hydrosilation reaction catalyst in a catalytic amount.

2. The curable organopolysiloxane composition according to claim 1, wherein 50 mol % or more of all the terminal siloxy-groups of component (B1) have at least one silicon-bonded hydrogen atom.

3. The curable organopolysiloxane composition according to claim 1, wherein the [Si—H]mass % of component (B1) satisfies following equation:
0<[Si—H]mass %<3.5/(DP)^{0.5}
and the DP is in the range from 5 to 500.

4. The curable organopolysiloxane composition according to claim 1, wherein the composition further comprises an organopolysiloxane resin comprising R₃SiO_{0.5} units and at least one of RSiO_{1.5} units or SiO_{2.0} units, where R is independently a monovalent organic group or a hydroxyl group or an alkoxy group, and the content of the organopolysiloxane resin is less than 40 mass % of the total amount of the solid components of the composition.

5. The curable organopolysiloxane composition according to claim 4, wherein:
component (A) is (A1) a linear organopolysiloxane having at least two alkenyl groups in each molecule with an alkenyl content in the range of from 0.005 to 1.50 mass %;
component (B) is (B1′) a linear organohydrogenpolysiloxane having at least three silicon-bonded hydrogen atoms, wherein the average number (DP) of siloxane units in each molecule calculated from the number average molecular weight is in the range from 8 to 300, 50 mol % or more of all the terminal siloxy-groups of component (B1′) have at least one silicon-bonded hydrogen atom, and the [Si—H] mass % of component (B1′) satisfies the following equation:
0<[Si—H]mass %<3.5/(DP)^{0.5}
and;
the content of the organopolysiloxane resin, where R is independently a monovalent organic group, is equal to or less than 20 mass % of the total amount of the solid components contained in the composition.

6. The curable organopolysiloxane composition according to claim 1, wherein when a cured layer having a thickness of 30 μm is formed from the composition on a polyethylene terephthalate film having a thickness of 75 μm, the adhesive strength of the cured layer to the film is in the range from 0.5 to 20.0 gf/25 mm as measured according to the 180-degree peel test method specified in the Japanese Industrial Standards Z 0237.

7. The curable organopolysiloxane composition according to claim 1, wherein when a cured layer having a thickness of 30 μm is formed from the composition on a polyethylene terephthalate film having a thickness of 75 μm, the adhesive strength of the cured layer to the film is in the range from 0.5 to 15.0 gf/25 mm as measured according to the 180-degree peel test method specified in the Japanese Industrial Standards Z 0237.

8. The curable organopolysiloxane composition according claim 1, wherein the composition is substantially free from an organopolysiloxane resin comprising R₃SiO_{0.5} units and at least one of RSiO_{1.5} units or SiO_{2.0} units, where R is independently a monovalent organic group, and when a cured layer having a thickness of 30 μm is formed from the composition on a polyethylene terephthalate film having a thickness of 75 μm, the adhesive strength of the cured layer to the film is in the range from 0.5 to 10.0 gf/25 mm as measured according to the 180-degree peel test method specified in the Japanese Industrial Standards Z 0237.

9. A primer composition, an adhesive composition, or a coating composition, with the composition comprising the curable organopolysiloxane composition according claim 1.

10. A pressure-sensitive adhesive (PSA) composition consisting of a cured composition formed from the curable organopolysiloxane composition according to claim 1.

11. A release coating composition consisting of the curable organopolysiloxane composition according to claim 1.

12. An article comprising a layer of cured organopolysiloxane composition which is prepared by curing the curable organopolysiloxane composition according to claim 1.

13. A laminate comprising a substrate and a layer of cured organopolysiloxane composition, which is prepared by curing the curable organopolysiloxane composition according to claim 1 in the form of a thin film.

14. The laminate according to claim 13, wherein the layer of the cured composition is at least one selected from the group consisting of an adhesive layer, a release coating layer, and a primer layer.

15. An optical article comprising the laminate according to claim 13.

16. A protective film comprising the laminate according to claim 13.

17. A pressure-sensitive adhesive composition comprising the curable organopolysiloxane composition according to claim 1 or a cured product thereof.
